(19) United States
(12) Patent Application Publication
(10) Pub. No.: US 2007/0165413 A1
(43) Pub. Date: Jul. 19, 2007

(54) LOW PROFILE LIGHTING SYSTEM

(76) Inventors: Susan H. Sanner, San Clemente, CA (US); John S. Carruthers, San Clemente, CA (US)

Correspondence Address: KIRKPATRICK & LOCKHART PRESTON GATES ELLIS LLP, 1900 MAIN STREET, SUITE 600, IRVINE, CA, 92614-7319, US

(21) Appl. No.: 11/552,214

(22) Filed: Oct. 24, 2006

Related U.S. Application Data
(60) Provisional application No. 60/730,328, filed on Oct. 25, 2005.

(51) Int. Cl. F21V 15/00

(52) U.S. Cl. 362/362

(57) ABSTRACT

A low profile lighting system and method for illuminating objects for enhanced visual perception and for providing an energy-efficient and effective lighting system. The low profile lighting system comprises a first housing unit for housing an electronic unit, a second housing unit for housing at least one light source unit and at least one voltage supplier. The electronic unit, the light source unit(s), and the voltage supplier(s) are all electrically connected. The light source unit further comprises a plurality of light emitting diodes (LEDs) connected in series to form different configurations. Additionally, the intensity, luminosity, and brightness of the light output from the light source unit is adjustable between a predetermined maximum and minimum value for producing safe light over an object.

### CROSS REFERENCE TO RELATED APPLICATIONS

The present application claims the benefit under 35 U.S.C. §119(e) of U.S. Provisional Application No. 60/730,328 filed Oct. 25 2005.

### FIELD OF THE INVENTION

The present invention relates generally to lighting systems and, more particularly to a low profile lighting system which enhances visual perception of such objects by varying brightness, intensity, or luminosity. The present invention also relates generally to a method of lighting objects and, more particularly to a method of low profile lighting by placing the light source behind, beneath, beside or on top the object, directing the light from the light source onto the object and setting the intensity, luminosity, and brightness of the light source.

### BACKGROUND OF THE INVENTION

Illumination of objects of art is pleasing because it enhances visual perception by complimenting the contents of the art objects. Art lighting allows objects of art to come alive with their true colors. Lighting of art objects is considered critical because even a slight difference in direction or type of light can significantly alter viewers' perception of the artwork. In the field of art lighting, several different lighting systems are well known.

First, gallery style lighting is one of the traditional lighting systems used to illuminate artwork. In this system, overlapping beams from a series of individual lights, mounted on a track, are aimed at the artwork. Gallery style lights are typically located on the ceiling or placed high above the artwork to reduce heat from radiation. Nevertheless, the artwork is exposed to heat radiation in a gallery style lighting system.

Second, incandescent lighting is one of the traditional lighting systems used for picture lighting. Although incandescent lights bring out the warm colors in an artwork such as the red, brown, orange, and yellow tones, they do not bring out blue, green, and violet tones. Further, the artwork is exposed to excessive heat because light from an incandescent lamp is generated by heating the filament to “incandescence” i.e. to temperatures above 200 degrees celsius.

Third, fluorescent lights are sometimes used to light artwork. Although fluorescent lamps produce less heat than incandescent lamps, they generate high amounts of damaging UV rays. Another disadvantage with using fluorescent lamps to light artwork is that the lamps do not emit light across the entire color spectrum and therefore, do not bring out the true colors in an artwork.

Finally, halogen lights are another light source available for art lighting. Halogen lamps are available in various wattages; at low wattage, the halogen lamps produce less heat and UV rays. In addition, some halogen lamps, namely the MR lamps, are provided with precise mirrored reflectors that gather the light from the filament to create a concentrated beam of light that can illuminate the entire height of the artwork. However, MR lamps are not energy efficient when used in applications where directional lighting is not necessary.

The present invention is directed to overcoming one or more of the problems set forth above.

### SUMMARY OF THE INVENTION

It is a primary object of the present invention to provide a low profile lighting system which enhances visual perception of objects by varying brightness, intensity, or luminosity. The present invention is designed to overcome certain problems with well known lighting system such as those noted above.

In one aspect of the invention, the low profile lighting system comprises a first housing unit having an electronic unit, a second housing unit having a light source unit, and a voltage supplier. The light source unit is electrically connected to the electronic unit, and the electronic unit is electrically connected to the voltage supplier. The light source unit comprises a plurality of Light Emitting Diodes (LEDs) which produce a light output. The intensity, luminosity, and brightness of the light is adjustable and the maximum intensity, luminosity, and brightness of the light can be varied.

In a specific embodiment, the light source unit comprises a plurality of LEDs connected in series. When connected in series, the LEDs must be safely operated at the same current level. In another embodiment, the plurality of LEDs may be connected in a parallel wiring arrangement. In such an arrangement, all the LEDs consume at or near the same level of current albeit lower than when connected in series. In yet another embodiment, the plurality of LEDs may be electrically connected in a series-parallel arrangement. In this arrangement, a given number of LEDs are connected in series to form a “diode group.” The “diode groups” are then electrically connected to one another in a parallel wiring arrangement.

In a specific embodiment, the plurality of LEDs are all of the same color. In another embodiment, the plurality of LEDs may be of different colors. The different-colored LEDs may be arranged in a predetermined pattern or in a pattern as specified by the viewer of an artwork. Further, the different-colored LEDs may be distinctly grouped with each group consisting of LEDs of the same color.

In a specific embodiment, the LEDs are soldered to a printed circuit board and arranged in a circle. In another embodiment, the LEDs may be soldered to a printed circuit board and arranged to form a star, square, or any other pattern or shape. A viewer or purchaser may chose a particular arrangement of LEDs for the light source unit.

In a second aspect of the invention, the electronic unit of the low profile lighting system delivers constant luminosity for the LEDs in the light source unit. In an alternate embodiment, the electronic unit of the lighting system causes the plurality of LEDs in the light source unit to blink on and off at a specified time interval. The specified time interval may be at a predetermined value or a value that may be set by a viewer.

In a third aspect of the invention, method of lighting objects and, more particularly to a method of low profile lighting by placing the light source in proximity to the object wherein the light source unit is behind, beneath, beside or on top the object, directing the light from the light source onto the object and setting the intensity, luminosity, and brightness of the light source are provided.

In one embodiment, the method of lighting objects comprises the steps of adjusting the position of the light source unit relative to the object and varying the intensity, luminosity, and brightness of the light source unit between a predetermined range of minimum and maximum values.

The present invention may be used to light objects selected from the group consisting of art objects, antiquities, artifacts, paintings, drawings, sculptures, tapestries, and prints.

### BRIEF DESCRIPTION OF THE DRAWINGS

FIG. 1 is the perspective view of a low profile lighting system according to one embodiment of the present invention.

FIG. 2A-C show the circuit diagram of the light source unit according to more than one embodiment of the present invention.

FIG. 3 shows the circuit diagram of the electronic unit according to one embodiment of the present invention.

FIG. 4 shows the circuit diagram of the electronic unit according to another embodiment of the present invention.

FIG. 5 shows the block diagram according to one embodiment of the present invention.

### DETAILED DESCRIPTION OF THE INVENTION

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. All references cited herein are incorporated by reference herein in their entirety.

As used herein, the term “transparent” is defined as any material having the property of being able to transmit and diffuse light passing through the material so that objects can be seen through the material in varying, and preferably controlled, degrees of clarity. “Transparent” includes the term “translucent” defined as any material having the property of transmitting and diffusing light so that objects beyond cannot be seen clearly.

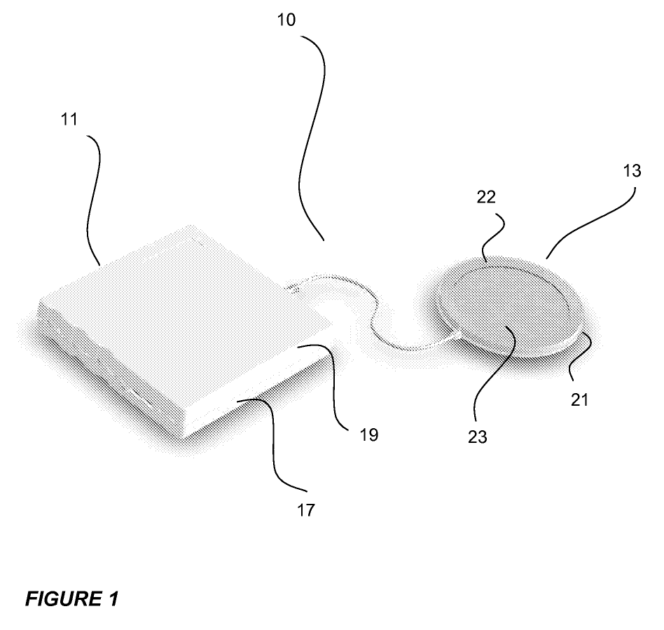

FIG. 1 shows the perspective view of one embodiment of the present invention. A low profile lighting system 10 comprises a first housing unit 11 having an electronic unit 12. The lighting system 10 further comprises a second housing unit 13 having at least one light source unit 14 and at least one voltage supplier 15. The light source unit 14 further comprises a plurality of diodes 16 which produce a light output. The intensity, luminosity and brightness of the light output is adjustable from the electronic unit. Additionally the maximum intensity, luminosity and brightness can also be set and varied from the electronic unit. Light source unit 14 is electrically connected to the electronic unit 12, and the electronic unit 12 is electrically connected to the voltage supplier 15.

The first housing unit 11 of the low profile lighting system 10 comprises a first base 17 having a flat bottom wall 18, a sidewall extending from the bottom wall upward on each of the four sides, three of the sidewalls having at least one slot, and a first protective cover 19 having a flat upper wall 20, a sidewall extending from the upper wall downward on each of the four sides, and three of the sidewalls having at least one slot. The first base 17 and the first protective cover 19 are hinged along one sidewall, the slots on the sidewalls of the first base and the first protective cover are aligned to one another. The electronic unit 12 is attached to the first base 17 using material from the group consisting of glue, and resin.

The first base 17 and the first protective cover 19 are preferably molded of durable plastic, brass, or composite material. The electronic unit 12 is preferably a printed circuit board having all the electronic components soldered therein.

The second housing unit 13 of the low profile lighting system 10 further comprises a second base 21, a second protective cover 22, and a lens 23. The light source unit 14 and the lens 23 are loosely held between the second protective cover 22 and the second base 21. Screws hold the second base 21 and the second protective cover 22 together.

The second protective cover 22 is preferably molded of a transparent durable plastic, brass, or composite material. The lens 23 is preferably molded of a transparent, colorless, durable plastic such as acrylic plastic. Even glass or fused glass may be used as a material for the lens 23 in lieu of acrylic plastic. The term “transparent”, as used herein simply means being capable of transmitting light so that the image can be seen as if there was no intervening material. The transparent material can be made of that material identified above, or like material so long as it can transmit light therethrough.

The low profile lighting system 10 also includes a voltage supplier 15. The voltage supplier 15 shown in FIG. 1 is a standard AC-DC adaptor that may be plugged into any standard AC power outlet via a plug 25. Particularly, an adaptor manufactured by CUI, Inc. with the following settings may be used: input of 100-240 v˜50/60 Hz; input current of 0.35 A MAX; and an output of 5.0 v/2.0 A.

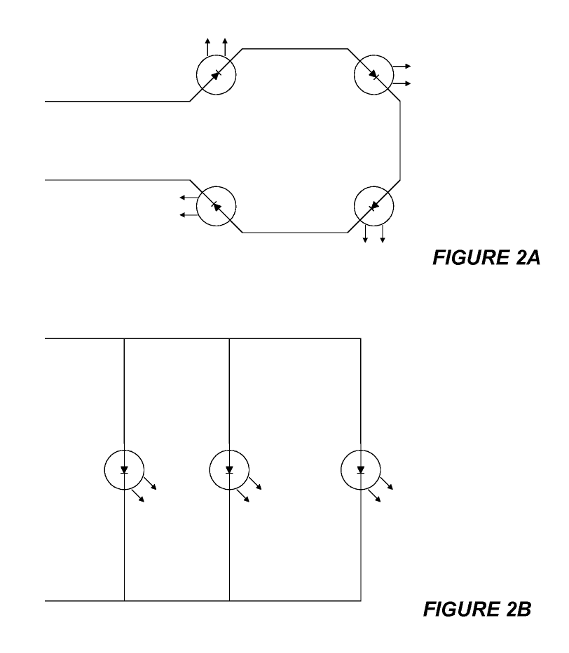

FIGS. 2A-C show the circuit diagram of the light source unit according to more than one embodiment of the present invention. In FIG. 2A, the light source unit 14 comprising a plurality of diodes 16, particularly, light emitting diodes (LEDs) are serially connected to each other. When connected in series, the LEDs must be safely operated at the same current level. In FIG. 2B, the plurality of LEDs may be connected in a parallel wiring arrangement. In such an arrangement, all the LEDs consume at or near the same level of current albeit lower than when connected in series. In FIG. 2C, the plurality of LEDs may be electrically connected in a series-parallel arrangement. In this arrangement, a given number of LEDs are connected in series to form a “diode group.” The “diode groups” are then electrically connected to one another in a parallel wiring arrangement.

In a specific embodiment of the present invention, the plurality of LEDs are all of the same color. The same-colored LEDs may be electrically connected to each other to form different configuration patterns. The LEDs are soldered to a printed circuit board and arranged in a circle. In another embodiment, the LEDs may be soldered to a printed circuit board and arranged to form a star, square, or any other pattern or shape. A viewer or purchaser may choose a particular arrangement of LEDs for the light source unit.

In another embodiment, the plurality of LEDs may be of different colors. The different-colored LEDs may be arranged in a predetermined pattern or in a pattern as specified by the viewer. Further, the different-colored LEDs may be distinctly grouped with each group consisting of LEDs of the same color.

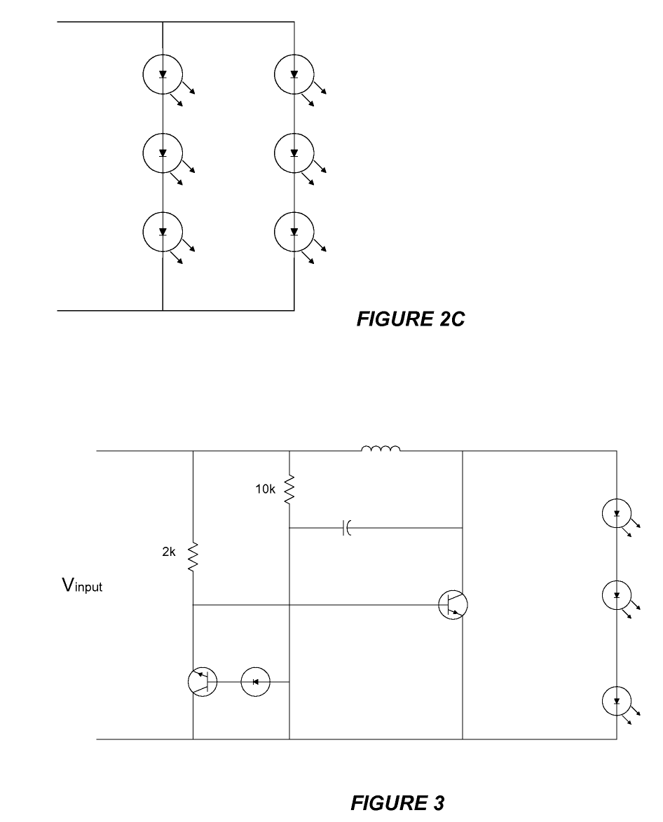

FIG. 3 shows the circuit diagram of the electronic unit according to one embodiment of the present invention. The preferred circuitry of this aspect of the invention uses two transistors, a diode, two resistors, an inductor, a capacitor, and three LEDs. The control circuitry is generally laid out in functional blocks in accordance with FIG. 3.

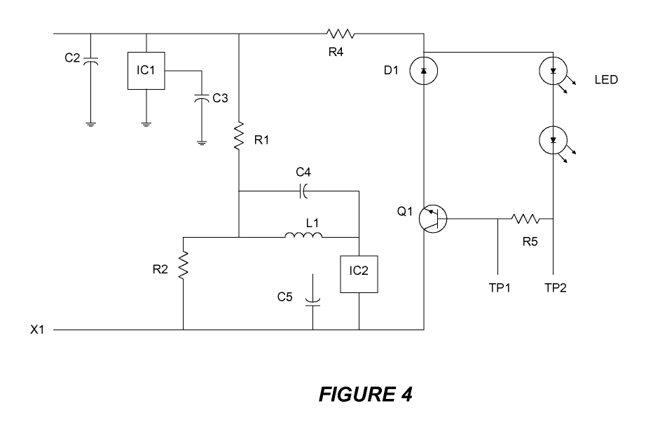

FIG. 4 shows the circuit diagram of the electronic unit according to another embodiment of the present invention. In the circuit illustrated in FIG. 4, preferred component values and/or part types are given in the table below. This list, in conjunction with the schematic and other disclosure herein, will enable a person skilled in the art to construct the circuit disclosed. This list, with such differences as will be appreciated by those skilled in the art also illustrates components of other topologies and embodiments disclosed herein.

| Drawing Numerals | Part Type |
|---|---|
| IC1 | 8HA |
| IC2 | 12F683 |
| D1 | 1N4148 |
| Q1 | f7343 |
| L1 | 10 uH +/− 15% |
| R1-R5 | 1-40 kΩ |
| C1-C4 | 10-100 μF |

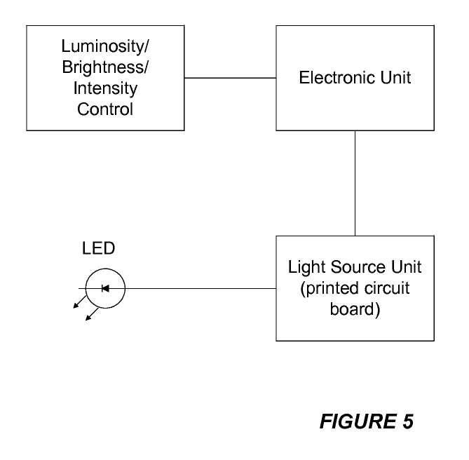

FIG. 5 shows the block diagram according to one embodiment of the present invention. FIG. 5 shows an embodiment for controlling the light source unit 14. In this embodiment, an intensity/luminosity/brightness control unit controls the intensity/luminosity/brightness of the LEDs in the light source unit.

The present invention may be used to illuminate antiquities, artifacts, paintings, drawings, sculptures, tapestries, and prints. The use of the invention is however not limited to the objects mentioned above but may also be used with other types of objects. In one embodiment the object is a glass sculpture and the object is lit from beneath the object.

What is claimed is:

1. A low profile lighting system comprising:
a first housing unit having an electronic unit;
a second housing unit having at least one light source unit comprising a plurality of diodes producing a light output;
at least one voltage supplier,
wherein said light source unit is electrically connected to said electronic unit, and
said electronic unit is electrically connected to said voltage supplier.

2. The low profile lighting system of claim 1 wherein said first housing unit further comprises:
a first base having a flat bottom wall, an open top, a sidewall extending from said bottom wall upward on each of four sides, three of said sidewalls having at least one slot, and
a first protective cover having a flat upper wall, an open bottom, a sidewall extending from the upper wall downward on each of the four sides, and three of said sidewalls having at least one slot,
wherein said first base and said first protective cover are hinged along one sidewall, said slots on the sidewalls of the first base and the first protective cover are aligned to one another, and said electronic unit is attached to said first base using material from the group consisting of glue and resin.

3. The low profile lighting system of claim 2 wherein said first protective cover and said first base are fabricated from material selected from the group consisting of brass, plastic, and composites.

4. The low profile lighting system of claim 1, wherein the intensity, luminosity and brightness of said light are adjustable.

5. The low profile lighting system of claim 1 wherein the maximum intensity, luminosity and brightness of said light can be varied.

6. The low profile lighting system of claim 1 wherein said second housing unit further comprises a second base, a second protective cover, and a lens;
wherein said light source unit and said lens are loosely held between said second protective cover and said second base, and said second base and said second protective cover are fastened together.

7. The low profile lighting system of claim 6 wherein said second protective cover and said second base are fabricated from material selected from the group consisting of brass, plastic, and composites.

8. The low profile lighting system of claim 6 wherein said lens is fabricated from material selected from the group consisting of glass, fused glass, and transparent plastic.

9. The low profile lighting system of claim 1 wherein said diodes are light emitting diodes (LED).

10. The low profile lighting system of claim 1 wherein said plurality of diodes are serially connected.

11. The low profile lighting system of claim 1 wherein said plurality of diodes are connected in parallel.

12. The low profile lighting system of claim 1 wherein a given number of said diodes are connected in series to form a diode group and said diode groups are connected in parallel.

13. The low profile lighting system of claim 1 wherein said plurality of diodes are electrically connected and arranged to form different patterns.

14. The low profile lighting system of claim 1 wherein said voltage supplier is selected from the group consisting of battery, DC voltage supplier, and AC-DC adaptor.

15. The low profile lighting system of claim 1 wherein said voltage supplier supplies voltage in the range of zero to five (5) volts.

16. The method of lighting objects comprising the steps of:
placing at least one low profile lighting system in proximity to said object wherein said light source unit of said low profile lighting system is disposed behind, beneath, beside or on top of said object;
directing the light from said light source unit onto said object; and
setting the intensity, luminosity, and brightness of at said least one light source unit.

17. The method according to claim 16, further comprising the steps of adjusting the position of said light source unit relative to the object.

18. The method according to claim 16, further comprising the steps of varying the intensity of said light source unit between a predetermined range of minimum and maximum values.

19. The method according to claim 16, further comprising the steps of varying the brightness of said light source unit between a predetermined range of minimum and maximum values.

20. The method according to claim 16, further comprising the steps of varying the luminosity of said light source unit between a predetermined range of minimum and maximum values.

21. The method according to claim 16, wherein said object is selected from the group consisting of art objects, antiquities, artifacts, paintings, drawings, sculptures, tapestries, and prints.
